(19) United States
(12) Patent Application Publication
(10) Pub. No.: US 2008/0201722 A1
(43) Pub. Date: Aug. 21, 2008

(54) Method and System For Unsafe Content Tracking

(75) Inventor: Gurusamy Sarathy, Vancouver (CA)

Correspondence Address: MCANDREWS HELD & MALLOY, LTD, 500 WEST MADISON STREET, SUITE 3400, CHICAGO, IL, 60661, US

(73) Assignee: Gurusamy Sarathy, Vancouver (CA)

(21) Appl. No.: 11/676,754

(22) Filed: Feb. 20, 2007

(51) Int. Cl. G06F 3/00

(52) U.S. Cl. 719/311

(57) ABSTRACT

Certain embodiments of the present invention provide methods and systems for registering and categorizing content in a network. Certain embodiments provide a method for registering and categorizing content passing through a gateway in a network. The method includes registering content at a network gateway. Registering includes an initial categorization of the content according to at least one category based on at least one characteristic. The method also includes allowing delivery of the initially categorized content to at least one node based on the initial categorization. The method further includes re-categorizing the content based on additional information. Additionally, the method includes identifying, based on the at least one category and the re-categorized content, one or more nodes associated with the initially categorized content. Furthermore, the method may also include remediation of the node(s) associated with the re-categorized content and removal from quarantine or removal of restrictions on delivery of content.

### BACKGROUND OF THE INVENTION

The present invention generally relates to detection of malware. More particularly, the present invention relates to tracking an outbreak of malware and/or unwanted content, whether it be data or executable code, in a network and auditing of recovery activities.

Malware is a general type of a computer contaminant including computer viruses, worms, Trojan horses, spyware and/or adware, for example. Unlike defective software which has a legitimate purpose but which may contain errors, malware is written to infiltrate or damage a computer system and/or other software. Malware may also steal sensitive information, such as passwords. Some malware programs install a key logger, which copies down the user's keystrokes when entering a password, credit card number, or other useful information.

Malware includes viruses and worms, which spread to infect other executable software and/or computers locally and/or over a network, for example. By inserting a copy of itself into the machine code instructions in these executables, a virus causes itself to be run whenever the program is run or the disk is booted.

Additionally, Microsoft Word® and similar programs include flexible macro systems receptive to macro viruses that infect documents and templates, rather than applications, through executable macro code.

Worms, unlike viruses, typically do not insert themselves into other programs but, rather, exploit security holes in network server programs and start themselves running as a separate process. Worms typically scan a network for computers with vulnerable network services, break in to those computers, and replicate themselves.

Another type of malware is a Trojan horse or Trojan. Generally, a Trojan horse is an executable program that conceals a harmful or malicious payload. The payload may take effect immediately and can lead to many undesirable effects, such as deleting all the user's files, or the payload may install further harmful software into the user's system. Trojan horses known as droppers are used to start off a worm outbreak by injecting the worm into users' local networks.

Spyware programs are produced for the purpose of gathering information about computer users and their activities.

Additionally, systems may become infected or contaminated with unwanted content. Unwanted content is defined as being data or executable code that is transmitted, received, stored, installed or used without the system owner's permission. Although unwanted content may not be malicious, it can either affect performance of day-to-day activities or potentially introduce security risks and related legal risks into an organization. Such unwanted content may include email-borne spam, Instant Messaging spam (commonly known as “spim”), “phish” email, adware, dialers, remote administration tools and hacking tools.

Traditional malware and unwanted content protection techniques are based around anti-virus and anti-spam vendors creating signatures for known malware and products that scan systems searching for those specific signatures.

In traditional approaches, an identification or definition of malware and/or unwanted content is released once a lab has seen and analyzed a sample of such content. This can mean that some users may be contaminated before the definitions have been released.

The volume of malware has increased dramatically (around 140+ Brazilian Banking Trojans per day for example). Multiple variants of the same malware threat are relentlessly created and rapidly distributed, with the aim of defeating traditional signature-based virus protection.

Some anti-virus software uses heuristics to attempt to identify unknown viruses. Heuristics techniques look at various properties of a file and not necessarily the functionality of the program. This leads to high false positive rates.

Other behavior based technologies rely on running malware and attempting to stop execution if malicious behavior is observed to happen. By allowing malware to execute, the malware may already have caused damage before it is blocked. Additionally, behavior-based technology often requires extensive user interaction to authorize false positives.

The network security threats faced by enterprises today are much more complex than 20 years ago. The exponential growth in malware is compounded by its speed of propagation and the complexity of blended threats, changing the nature of the risks. The behavior of network users is also changing rapidly.

Currently, recovery from malware and unwanted content outbreaks within computer networks is a very manual process. Existing systems are limited to reporting whether the nodes in a network have up-to-date protection installed. Systems do not provide insight into which nodes within the network may be potentially unsafe due to a previously unknown threat that might have entered the network prior to protection becoming available. Thus, systems and methods for unsafe node or content tracking would be highly desirable. Additionally, systems and methods for tracking malware and unwanted content outbreaks in a network and auditing recovery from such outbreaks in the network would be highly desirable. Furthermore, there is a need for systems and methods for monitoring installation of software updates at nodes in a network.

### BRIEF SUMMARY OF THE INVENTION

Certain embodiments of the present invention provide methods and systems for registering and categorizing content in a network.

Certain embodiments provide a method for registering and categorizing content passing through a gateway in a network. The method includes registering content at a network gateway. Registering includes an initial categorization of the content according to at least one category based on at least one characteristic. The method also includes allowing delivery of the initially categorized content to at least one node based on the initial categorization. The method further includes re-categorizing the content based on additional information regarding at least one characteristic. Additionally, the method includes identifying, based on the at least one category and the re-categorized content, one or more nodes associated with the initially categorized content.

Certain embodiments provide a system for registering and categorizing content at a gateway in a network. The system includes a registration subsystem for registering and performing a categorization of content at a gateway in a network. The registration subsystem is configured to re-categorize the content based on additional information. The system also includes a quarantine subsystem for identifying one or more nodes associated with the re-categorized content, determining whether the re-categorized content is still associated with the identified nodes and quarantining one or more nodes still associated with the re-categorized content based on the re-categorization.

Certain embodiments provide a computer-readable medium having a set of instructions for execution on a computer. The set of instructions include a registration routine for registering and performing a categorization of content at a network gateway facilitating delivery of the content to one or more nodes. The registration subsystem is configured to re-categorize the content based on updated information regarding the content. The set of instructions also includes a quarantine routine for identifying one or more nodes previously associated with the re-categorized content, determining whether the re-categorized content is currently associated with the identified nodes and quarantining one or more nodes currently associated with the re-categorized content based on the re-categorization.

### BRIEF DESCRIPTION OF SEVERAL VIEWS OF THE DRAWINGS

FIG. 1 illustrates an example of a computer network including content tracking used in accordance with an embodiment of the present invention.

FIG. 2 illustrates a flow diagram for a method for content tracking in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

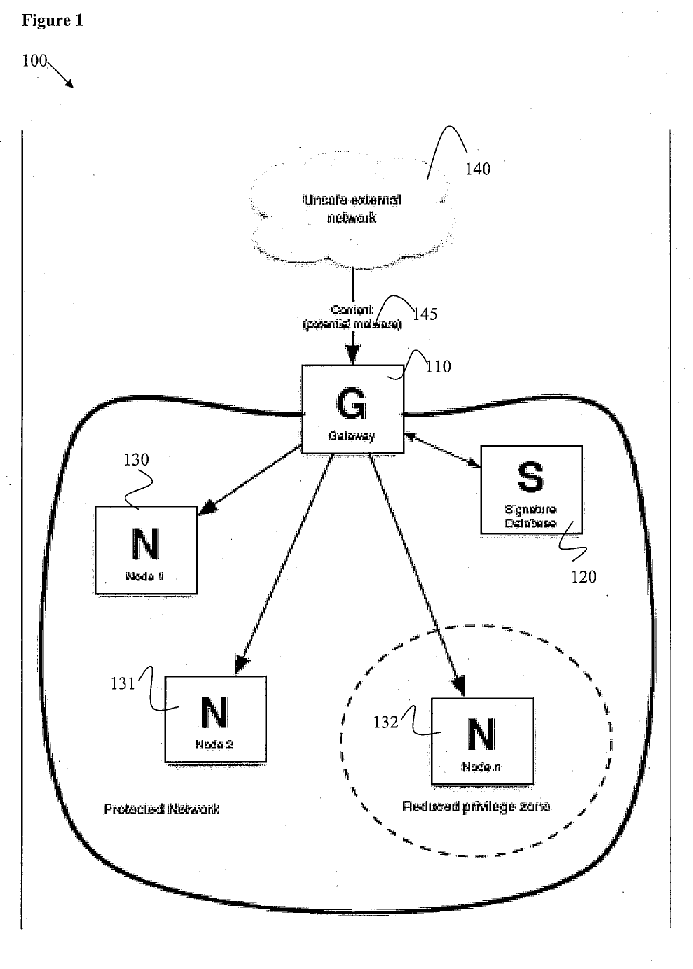

Certain embodiments relate to a private network of computer nodes that is bridged to a public network via specific gateways. FIG. 1 illustrates an example of a computer network 100 used in accordance with an embodiment of the present invention. A node in such a network is designated N in FIG. 1, and a gateway is designated G. Certain embodiments help enable gateway G to efficiently maintain a register of content that has been delivered to node N from gateway G. When a new malware threat is recognized or content is re-categorized as unsafe or unwanted, gateway G can consult its register of content that has been delivered to node N, identify node N as a compromised node, and take appropriate steps, such as placing node N in a status with least privilege, for example. Adjusting a node status helps to block the threat or content from further propagation. When protection for that specific threat or rules for that specific content is available, gateway G may allow node N to fetch and apply remediation measures and confirm that the remediation was successful, for example.

Computer network 100 includes a gateway 110, a signature database 120, and a plurality of nodes 130-132. The network 100 is connected to an external network 140. The external network provides content 145, which may potentially include malware, unsafe content and/or unwanted content to the gateway 110.

Gateway 110 maintains a database including signatures of content that has been delivered to nodes 130-132. Signatures can be of several different forms depending on the type of content. The signature maps content of an arbitrary length to a unique constant-sized bit string, such as a cryptographically strong hash function, for example. For a type of content, a hash function H is applied to selective parts of the content to identify a threat or a variation of the threat. The hash function computes one or more signatures S that are stored at gateway 110. In certain embodiments, storage requirements for S constitute a fraction of the space required to store the content itself. A signature S is stored along with auditing information, such as an address of node N 130-132 and a time and point of origin of the content. In certain embodiments using a unique hash function, retrieval of a record associated with any hash is a constant time operation, for example.

In certain embodiments, selection of portion(s) of the content to use in computing a signature is dependent on the type of content. For example, executable files that have been packed or randomized may have a layer of packing removed before signature generation. For some types of content, the signature may even be generated on broad characteristics of the content (its “genotype”) rather than the actual content itself.

When malware or unsafe or unwanted content is recognized at gateway 110, a signature is computed for the malware content or unsafe or unwanted content, as for all other content. Gateway 110 then looks for a matching signature in signature database 120. If the signature is found, gateway 110 places the node(s) 132 associated with the previous instance of the content in a network quarantine, which limits the node(s) from propagating the malware or unsafe or unwanted content further. Administrative alerts may be issued to identify a quarantined node 132 and track node 132 status.

Node(s) 132 that are placed in the quarantined status execute remediation measures before the node(s) 132 can become normal participants of the network. Remediation measures track the number of instances of malware or unsafe or unwanted content that were identified and cleaned, for example. If the node status information matches the information tracked by gateway 110, the node 132 is taken out of quarantine, for example.

In operation, for example, consider gateway 110 to be an email hub (such as a Post Office Protocol (“POP”) or Internet Message Access Protocol (“IMAP”) server, for example Microsoft Exchange). Nodes 130-132, such as email clients running on desktop computers, are serviced by gateway 110. When a client connects to gateway 110 to get or send electronic mail, gateway 110 decomposes Multipurpose Internet Mail Extension (“MIME”) encoded email into parts. Each part is checksummed using a function, such as a strong signature function (MD5 or SHA1, for example). The checksums, the messages to which the checksums apply, and client hostnames/Internet Protocol (“IP”) addresses that fetched/sent the messages are maintained in a database table by gateway 110. The checksum verification happens continuously as email is processed on gateway 110.

Additionally, gateway 110 may include anti-virus, anti-spam, or application control software. The anti-virus, anti-spam, or application control software scans MIME parts that are processed by gateway 110. In certain embodiments, the anti-virus, anti-spam, or application control software is updated periodically to recognize new threats, unwanted content, or unwanted applications. Such updates provide both recognition for new threats, as well as signatures of samples that have already been seen.

Given the reactive nature of anti-virus, anti-spam, and application control software, there is a window of opportunity where a new threat could have slipped by a gateway before protection from the threat became available and was deployed on gateway and nodes. However, in certain embodiments, when a new threat update is available and when new malware or unsafe or unwanted content is identified on gateway 110, gateway 110 can check its signature database 120 of past content and determine if any of the signatures in the database 120 match signature(s) provided in a threat update or found to match the newly identified malware or unsafe or unwanted content. If a match is found, gateway 110 can identify nodes 130-132 that are potentially compromised and take further action to protect the network 100.

For example, gateway 110 may communicate with a network firewall to provide the firewall with a hostname and IP address of the potentially compromised node. The firewall can then “lock down” network traffic to and from the potentially compromised node to limit the node only to traffic from/to the anti-virus software that is installed on the node 132. When the anti-virus software on the node 132 successfully cleans the node 132, the software can notify the firewall. The anti-virus software, in conjunction with the gateway 110 and/or administrator discretion, restore full network connectivity to the node 132.

As another example, if the signature was seen in inbound mail, gateway 110 may quarantine copies of the message(s) that were addressed to multiple recipients where some recipient nodes have not yet fetched the mail. The gateway 110 notifies an administrator for further action on the quarantined mail.

As yet another example, if the signature was seen in outbound mail, gateway 110 identifies addresses to which the outbound mail was sent and notifies an administrator for further action. The administrator may contact the secondary sites to which the mail was sent to alert the site(s) of the threat.

When malware or unsafe or unwanted content is identified on a node 132, node 132 can communicate with gateway 110 of the fact and the corresponding signature(s). Gateway 110 can then perform a signature lookup in database 120 to identify other nodes that might have received the same malware or unsafe or unwanted content.

In certain embodiments, a fuzzy checksum may be used instead of a strong checksum/hash. The fuzzy checksum considers some defining portions of the content and ignores portions that are subject to variation from one instance of the content to another. Use of a fuzzy checksum allows a single checksum to apply to a broader set of content that have the same threat or other characteristics. For example, a fuzzy checksum for email MIME parts may take into consideration one or more of a size of an email content part, a type of file (zip, exe, etc), a run of bytes at a specific offset into the file, and an occurrence of a string of bytes in the file. Another type of fuzzy checksum may be a mathematical function, such as Nilsimsa or Soundex, that returns hash values that are closer together if the original content was similar (as opposed to being identical), for example.

Certain embodiments limit growth of the signature database 120 to a particular size. Each signature entry that is added to the database 120 may also include a timestamp. In certain embodiments, after the database 120 reaches a predefined size limit (e.g., a limit set by a network or system administrator), whenever a new signature is added to the database 120, the oldest signature is simultaneously removed.

In certain embodiments, the database or other malware library includes one or more of saved checksums, malware patterns, virus and/or other malware definitions, gene information, information as classifications based on groupings of genes, etc. The library may be accessed to detect/classify malware or unsafe or unwanted content in a message or other file.

In certain embodiments, system 100 may include a distributed cache of signatures or checksums of malware, unsafe or unwanted content, as well as a distributed cache of signatures or checksums of known good content. For example, such a distributed cache can be used to partition the work of scanning on central servers such that only lookups of signatures or checksums will need to be performed on the individual nodes in the network. As another example, distributed caching of signatures and checksums can also reduce the quantity of signatures and checksums that will have to be transmitted to the nodes, since the nodes will only need to look up the signatures or checksums that they possess the corresponding content for. As still another example, such a distributed cache may be implemented over a conventional Domain Name System (DNS).

In certain embodiments, system 100 provides both immediate and scheduled scanning and disinfection. Malware or unsafe or unwanted content may be detected in a variety of ways, such as by comparing checksum of a file to a stored checksum value, pattern matching to identify known patterns in files, electronic mail and/or disk areas (e.g., boot sectors), emulating all or part of a file's code to try and detect malware, such as polymorphic viruses, which may reveal themselves during execution, and/or extracting and analyzing functionality from a file by matching genes and/or classifications defined from groupings of genes, e.g., PHENOTYPE™ classifications (PHENOTYPE™ is a trademark of the assignee of the present patent application). After detection, a user and/or system may be notified of detected malware or unsafe or unwanted content, and system 100 may automatically and/or upon request attempt to disinfect, quarantine or remove detected malware or malware fragments or unsafe or unwanted content from the file/email/disk area.

Pattern matching and other forms of detection may be performed using Virus Identity Files (IDEs) or other identity files that contain algorithms describing various characteristics of a virus and/or other malware or unsafe or unwanted content for use in recognition.

In certain embodiments, an engine loads and searches data from an input email message or other file. The engine may use pattern matching, for example, to compare sequences of code in the file to known code sequences identify a particular sequence of code that is similar or identical to malware or unsafe or unwanted content code. The engine may also combine pattern matching with heuristics to use general, rather than specific, rules to detect several variations in the same virus family, for example. The engine may also include a code emulator for detecting malware such as polymorphic viruses (self-modifying viruses), for example, and/or an on-line decompressor for scanning inside archive files. The engine may also include an OLE2 (object linking and embedding) engine for detecting and disinfecting macro viruses.

In certain embodiments, messages and/or other files may be scanned “on demand.” A user may identify files or groups of files to scan immediately. On-demand scanning may also be scheduled by a user. For example, the user specifies a time at which to scan a selected group of files. At the scheduled time, selected files are scanned. A user or users may establish multiple schedules for scanning. Different configurations may be set for each scheduled scan. Alternatively and/or in addition, certain embodiments provide on-access malware or unsafe or unwanted content detection.

In certain embodiments, file or message open, close and/or other access requests, for example, are intercepted. The message or other file is scanned for malware or unsafe or unwanted content before the open, close and/or other access request is completed, for example.

In certain embodiments, a user may specify which files to check via a scheduled and/or on-access scan. That is, a user can include and/or exclude certain types of files from scanning. Additionally, the user may configure system 100 to check files on read, on write, and/or on rename, for example. The user may also configure system 100 to block access to the file, or to automatically initiate disinfection, removal and/or quarantine of a file upon finding malware or unsafe or unwanted content in the file.

In certain embodiments, system 100 may be used to identify malware or unsafe or unwanted content by extracting functionality from a file and classifying the functionality. In certain embodiments, classify functionality and identify malware or unsafe or unwanted content may be classified without requiring a most up-to-date set of definitions and/or signatures. A file and/or functionality within a file may be classified as malicious, non-malicious, suspicious, unsafe, unwanted, etc., based on functionality and/or relationships between or combinations of functionality, for example. Alternatively and/or in addition, particular programs represented by and/or included in the file may be identified.

Components of system 100 may be implemented in software, hardware and/or firmware, for example. The components of system 100 may be implemented separately and/or implemented in a variety of combinations. Components of system 100 may be implemented on a single computer system for processing software, data, and messages. Alternatively, components of system 100 may be implemented in a distributed network where different processes occur on different machines with a communication network to allow sharing of information. System 100 may be implemented using one or more software programs.

For example, registering and categorizing of content may be facilitated by a module integrated in the network and communicating with the gateway 110. The module registers and categorizes content at the gateway 110. When content is re-categorized in accordance with updates to the signature database 120, the module then identifies one ore more nodes 130-132 in the network which were associated with the content which has since been re-categorized. The module triggers a quarantine of such nodes 130-132.

As another example, the system 100 may be implemented as a routine configured to register and categorize content as it passes through a gateway and into a network and a quarantine routine configured to limit or exclude access to one or more nodes in the network associated with content which has been re-categorized unsafe or unwanted in accordance with updated rules or signatures. The routines or sets of instructions serve to detect and restrict access to nodes 130-132 in the system 100 as described above.

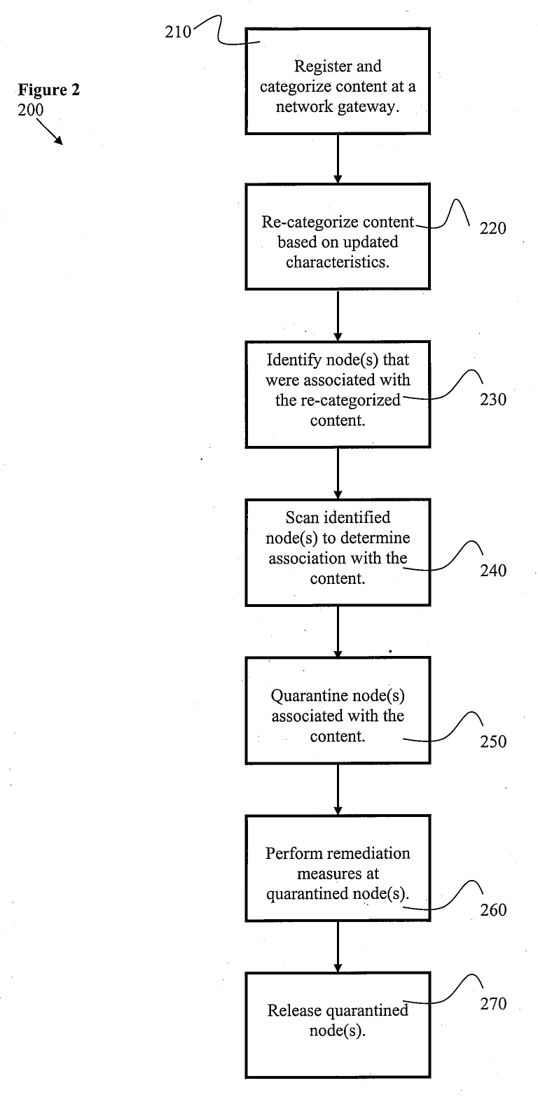

FIG. 2 illustrates a flow diagram for a method 200 for content tracking in accordance with an embodiment of the present invention. At step 210, content, such as malware, unsafe or unwanted content, entering a network via a gateway is registered and categorized. For example, malware is identified in a data file based on pattern matching from a virus definition. The data file is registered and categorized as malware or unwanted content.

At step 220, content is re-categorized based on updated category characteristics. Updated category characteristics may be provided at the gateway and/or at a node within the network, for example. Updated category characteristics may also be provided as a result of a manual update to category characteristics. For example, new malware or unwanted content has been identified and definitions and/or characteristics updated to reflect classification of the new malware or unwanted content.

At step 230, one or more nodes in the network that were associated with re-categorized content are identified based on previously registered content categories. For example, one or more nodes having content previously allowed but now classified as malware or unwanted content are identified. At step 240, the one or more identified nodes are scanned to determine whether the content is still associated with the nodes.

At step 250, one or more nodes associated with re-categorized content are quarantined. For example, traffic in to and/or out of a quarantined node may be limited and/or blocked based on a predefined scheme and/or set of rules.

At step 260, remediation measures are performed at quarantined node(s). For example, anti-virus software may be used to clean, delete and/or otherwise remove malware from the quarantined node(s) and/or other content entering the gateway. At step 270, remediated node(s) are reinstated with the network. That is, normal content traffic and routing is restored in the network with respect to the previously quarantined node(s). In certain embodiments, one or more of quarantine, remediation and release is automated.

One or more of the steps of the method 200 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

Certain embodiments provide systems and methods for controlling the delivery of certain categories of content, such as unsafe content or unwanted content. Certain embodiments provide registration of all or part of content at a network gateway.

Thus, certain embodiments provide systems and methods for tracking malware or unsafe or unwanted content outbreaks within networks and auditing recovery activities. Certain embodiments monitor whether software updates have been successfully consumed by certain nodes within a network. Certain embodiments help reduce or eliminate an awareness gap regarding “zero day” threats, and facilitate remediation of malware or unsafe or unwanted content outbreaks by identifying the nodes that may have been associated with such malware or unsafe or unwanted content and therefore need to be investigated.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for registering and categorizing content passing through a gateway in a network, said method comprising:
registering content at a network gateway, said registering including an initial categorization of said content according to at least one category based on at least one characteristic;
allowing delivery of said initially categorized content to at least one node based on said initial categorization;
re-categorizing said content based on additional information regarding said at least one characteristic;
identifying, based on said at least one category and said re-categorized content, one or more nodes associated with said initially categorized content.

2. The method of claim 1, wherein said additional information further comprises at least one updated characteristic.

3. The method of claim 2, wherein said at least one updated characteristic further comprises at least one of an updated category characteristic provided from an external source at the gateway and a manual update of a category characteristic.

4. The method of claim 2, wherein said at least one updated characteristic further comprises an identification of said initially categorized content as at least one of malware and unwanted content.

5. The method of claim 1, wherein said method further comprises generating a report regarding the content which is registered and categorized.

6. The method of claim 1, wherein said method further comprises controlling delivery of certain categories of content to at least one node in the network.

7. The method of claim 6, wherein said controlling delivery further comprises restricting delivery of certain categories of content to at least one node in the network.

8. The method of claim 1, wherein said identifying step further comprises scanning one or more nodes associated with said initially categorized content to identify whether said re-categorized content is still associated with the identified one or more nodes.

9. The method of claim 1, further comprising:
quarantining said one or more identified nodes; and
releasing said one or more quarantined nodes from quarantine after said re-categorized content has been remediated.

10. The method of claim 9, wherein at least one of said remediation and said release from quarantine is automated.

11. The method of claim 9, wherein said remediation comprises tracking a number of nodes identified and remediated and, if said number matches information tracked by said gateway, releasing said one or more nodes from quarantine.

12. The method of claim 1, wherein said re-categorization step further comprises computing a signature for said content and comparing said signature to signatures generated for categorized content.

13. The method of claim 1, further comprising remediating said content at said one or more quarantined nodes.

14. The method of claim 9, wherein said step of quarantining further comprises blocking access to said one or more identified nodes.

15. The method of claim 9, wherein said step of quarantining further comprises restricting access to said one or more identified nodes.

16. The method of claim 1, further comprising communicating with a network firewall to provide said firewall with an identification of a potentially compromised node.

17. The method of claim 1, further comprising identifying addresses to which said re-categorized content was sent and notifying at least one administrator associated with said addresses.

18. A system for registering and categorizing content at a gateway in a network, said system comprising:
a registration subsystem for registering and performing a categorization of content at a gateway in a network, said registration subsystem configured to re-categorize said content based on additional information; and
a quarantine subsystem for identifying one or more nodes associated with said re-categorized content, determining whether said re-categorized content is still associated with the identified nodes and quarantining one or more nodes still associated with said re-categorized content based on said re-categorization.

19. The system of claim 18, wherein at least one of said categorization and said re-categorization of said content is based on a signature database storing one or more signatures related to categorized content.

20. The system of claim 19, wherein a signature in said signature database further comprises at least one of a checksum, a malware pattern, a malware definition, gene information, and a classification based on a grouping of genes.

21. The system of claim 18, wherein anti-virus or application control software remediates said content at said one or more quarantined nodes.

22. The system of claim 18, wherein said quarantine subsystem facilitates an updating of software at said one or more quarantined nodes.

23. The system of claim 19, wherein said signature database stores, for a node, an address for said node, an origin of content at said node and a time of content arrival at said node.

24. The system of claim 19, wherein said signature database comprises a distributed signature database.

25. The system of claim 24, wherein said distributed signature database further comprises a distributed cache of signatures or checksums of at least one of malware, unsafe content and unwanted content and a distributed cache of signatures or checksums of at least one of known good content.

26. The system of claim 18, wherein said quarantine subsystem restricts access to said one or more nodes associated with said re-categorized content.

27. The system of claim 18, wherein at least one of said registration subsystem and said quarantine subsystem communicates with an external system regarding said re-categorized content.

28. A computer-readable medium having a set of instructions for execution on a computer, said set of instructions comprising:
a registration routine for registering and performing a categorization of content at a network gateway facilitating delivery of said content to one or more nodes, said registration subsystem configured to re-categorize said content based on updated information regarding said content; and
a quarantine routine for identifying one or more nodes previously associated with said re-categorized content, determining whether said re-categorized content is currently associated with the identified one or more nodes and quarantining one or more nodes currently associated with said re-categorized content based on said re-categorization.
